(19) United States
(12) Patent Application Publication
(10) Pub. No.: US 2004/0042738 A1
(43) Pub. Date: Mar. 4, 2004

(54) Closed space for optical fibre connection

(76) Inventors: Kaj Sjolin, Hudlksvall (SE); Robert Alexandersson, Hudiksvall (SE); Hasse Forslund, Sundsvall (SE); Mans Isacsson, Stenungsund (SE); Wiggo Nilsen, Nasviken (SE); Sam Jonsson, Forsa (SE); Niklas Paulsson, Iggesund (SE); Joakim Jorgensen, Hudiksvall (SE)

Correspondence Address: ERICSSON INC., 6300 LEGACY DRIVE, M/S EVW2-C-2, PLANO, TX, 75024, US

(21) Appl. No.: 10/433,040

(22) PCT Filed: Nov. 26, 2001
(86) PCT No.: PCT/SE01/02609

(30) Foreign Application Priority Data
Nov. 29, 2000 (SE) 0004394-3

(51) Int. Cl. G02B 6/36

(52) U.S. Cl. 385/89

(57) ABSTRACT

The present invention relates to a method and to a device for providing a closed chamber for the enclosure of optical fibre and/or optical fibre ribbon splices to a spliced underwater optical fibre cable. By providing the chamber (8) with at least one closable cover element, such as a cover plate (13), the chamber can be closed by means of said cover plate, subsequent to having inserted the ends of the optical fibre cables into said chamber and having spliced the optical fibres/optical fibre ribbons to said optical fibre cables. Oil can be delivered to the chamber closed by said cover plate, through at least one closable opening (14), resulting in a gas-tight and oil-filled chamber that provides reliable protection to the splices.

### FIELD OF INVENTION

The present invention relates to a method of providing a sealed chamber for enclosing optical fibre and/or optical fibre ribbon splices or joins made to an underwater optical fibre cable, and also to a sealed chamber provided in accordance with the method. The tensile strength of an underwater spliced optical fibre cable must be sufficient for the splices to be at least equally as strong as the optical fibre cable itself. The splices must also be protected effectively to prevent the ingress of water and/or gas, in other words the protection afforded by the splices must be as good as the protection afforded by the optical fibre cable per se.

### DESCRIPTION OF THE BACKGROUND ART

A splice on an underwater optical fibre cable is protected essentially by an external stainless steel tube that embraces an inner splice enclosing chamber in the form of a closed stainless steel container which protects the inwardly enclosed and spliced optical fibres and/or optical fibre ribbons of the optical fibre cable, including any connecting and coiled surplus optical fibres/optical fibre ribbon. The ends of the outer steel tube are connected to conical end-pieces that surround the optical fibre cables connected by the splices. The outer steel tube is also connected to means for joining the connecting reinforcing threads of the optical fibre cables, so that the splices will be at least as strong as the optical fibre cable per se. The inner splice-enclosing chamber may also be connected with, e.g., solder joints to the copper casings that surround the optical fibres in the two connecting optical fibre cables.

### SUMMARY OF THE INVENTION

With the intention of providing a gas-tight connection for optical fibres/optical fibre ribbons spliced or joined to an optical fibre cable, and then preferably an enclosure which is impervious to hydrogen gas, there has been provided a closable internal chamber or room for enclosing the optical fibres or optical fibre ribbons spliced to the optical fibre cable, wherewith the splicing chamber is gas-tight and filled with oil. The inner chamber includes small closable openings which enable leakage tests to be carried out and oil to be supplied to said inner chamber, subsequent to having spliced the optical fibres/optical fibre ribbons in the inner chamber and closing said chamber. An hermetically closed inner chamber, which may also be completely filled with oil, prevents the ingress of any hydrogen gas present into the optical fibres, therewith avoiding the effect that any hydrogen gas present would have on the optical fibre cable when drawing/laying the cable underwater.

The invention will now be described in more detail with reference to a preferred exemplifying embodiment and also with reference to the various figures in the accompanying drawing.

### BRIEF DESCRIPTION OF THE DRAWINGS

FIGS. 1A-C are respectively an exploded view and a cross-sectional view of a gas-tight splicing device constructed in accordance with the invention for splicing/joining together connected optical fibre cables, said figures also illustrating the design of a protective spacing tube.

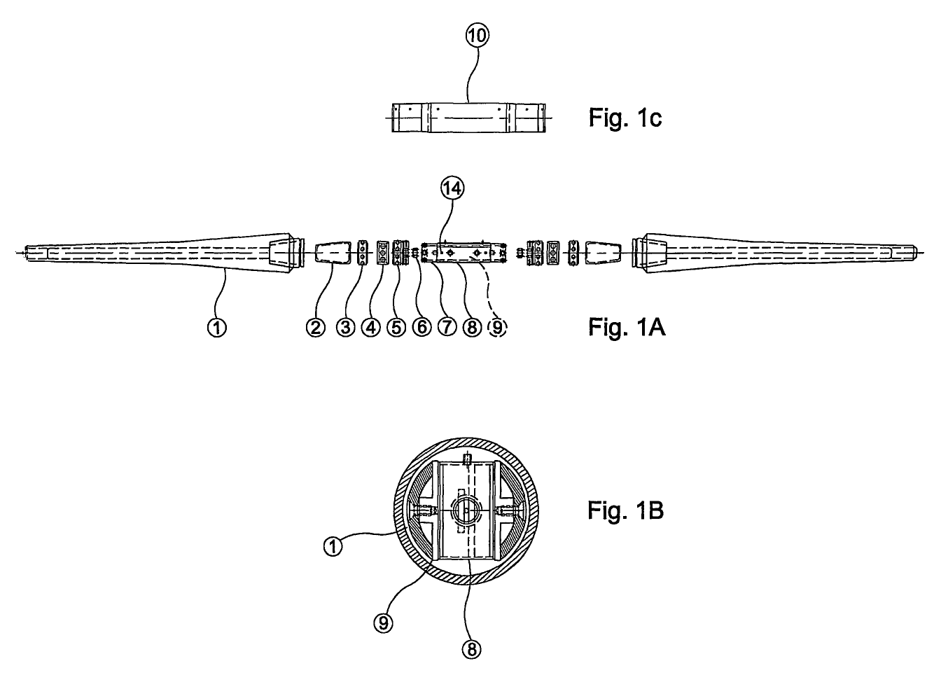

FIGS. 2A-C are enlarged and more detailed illustrations of the actual splicing chamber of the splicing device according to the invention.

### DESCRIPTION OF PREFERRED EMBODIMENTS

Before splicing together the ends of optical fibre cables, it is necessary first to prepare the cable ends. After having wound fibreglass tape around a respective cable end so as to fixate underlying material, such as the sheath (yam-winding?), around the cable, the sheath is cut adjacent the tape edge, wherewith that part of the sheath or winding which is still intact is held in place by the tape. When splicing together underwater cables, the protective sheath should be cut at a distance of at least 5 metres from the cable end. The optical fibre cable is exposed, by removing the sheath together with material present beneath the sheath. A bending limiting device 1 and a sealing cone 2 are fitted onto the exposed part of the cable. The bending limiting device includes a rubber guard which functions to protect the connection of the cable to the splices or joins. The sealing cone functions to seal the cable connection to the splices or joins. During assembly work, the bending limiting device and the sealing cone are moved away from the free end of the optical fibre cable through a distance of at least 3 to 4 metres, so as to facilitate splicing of the cable.

A first clamp is then placed around and secured to the optical fibre cable at a distance of approximately 1.6 metres from said end and is loosened by unwinding the sheathing yarn with plastic foil from around the reinforcing threads of the fibre cable and cutting away said yarn and foil, for instance with the aid of side cutting snippers.

A second clamp is then placed around and secured to the now exposed reinforcement threads, so that the distance between an outer edge of the first clamp and an outer edge of the second clamp will be about 135 mm, for instance. For example, a saw can be used to mark and make a fracture indication on all threads outwardly of the new clamp to an appropriate depth, it being ensured, if possible, that all exposed threads will have mutually the same length and that the layer beneath said threads is undamaged. The outer clamp is then removed and the first layer of reinforcement threads lifted out, this preferably being commenced from the cable end and with the threads mutually separated throughout the full distance to the remaining clamp. The threads are bent forwards and backwards at the previously made saw marks, until the threads break off, it being preferred to bend the ends of the threads inwardly, since this simplifies subsequent fitting of a fastener ring 3. Plastic tape may be used conveniently to hold pairs of threads together. This can be done to facilitate fitting of the fastener ring to said threads.

When a further clamp, a third clamp, is fastened around remaining reinforcement threads of an inner layer of reinforcement threads, the distance from the outer end of the remaining clamp to the outer end of the new clamp must be roughly 210 mm. A deep cut is made in each thread in the inner thread layer, while ensuring that all threads will have mutually the same length and that no damage has been made to the cable guard beneath the reinforcement threads, whereafter the new clamp is then removed. The outer fastener ring 3 is placed on the cable with holes facing towards the outer exposed reinforcement threads. The outer fastener ring is fitted over the cable to the now remaining clamp. With the reinforcement threads inserted in the holes on the fastener ring, the ring is pressed carefully towards the ends of the threads such that adequate lengths of said end portions will enter the holes.

The threads in the inner thread layer can then be separated from the end of the cable with an appropriate tool. The threads are then bent backwards and forwards at the location of the aforesaid saw mark, until the threads break off. In this regard, it is preferred to break-off the threads in a manner to achieve a residual inward bend, therewith facilitating fitting of a fastener ring 5. If the number of reinforcement threads, or wires, is greater than the number of holes in the fastener ring, the threads are held together in pairs by means of plastic tape, therewith facilitating insertion of the thread ends into the holes in the inner fastener ring 5.

After having released the inner reinforcement threads from the cable core and having cleaned the core, the inner fastener ring 5 is threaded onto the cable core and the reinforcement threads pressed into the holes in the fastener ring. With the outer reinforcement threads in position in the holes in the outer fastener ring 3 and the ends of the inner reinforcement threads in place in the holes in the inner fastener ring 5, the thread ends are clamped firmly in respective holes with the aid of locking screws that have a spacing sleeve 4 connected between the outer and the inner fastener ring. The position of respective fastener rings in relation to the thread ends can be adjusted relative to the thread direction, by loosening one or more locking screws. It is important that both fastener rings are orientated at right angles to the direction of cable alignment. An O-ring on the end of the cable can be sealingly fixated in the inner fastener ring 5, with the aid of a ring nut 6 provided with an external screw thread.

The ends of the reinforcement threads are fixed in fastener rings belonging to a second optical fibre cable that is to be spliced or joined to the first optical fibre cable in a manner similar to that aforementioned.

The cable ends projecting out from the fastener rings are freed step-wise from the various surrounding layers, wherewith the length of a copper casing beneath an outer protective casing is adapted first for soldering on a splice enclosing chamber 8, and an underlying casing is removed to expose the optical fibres located around a core that includes a force relieving means. The core with the tension relieving means is length-adapted and there is applied to the end of the exposed copper casing with remaining outer casing a layer of adhesive such as to form an adhesive casing around the optical fibres in the grooves on the core. The optical fibre cables are inserted through a hole in the chamber, wherewith the copper casing is intended for insertion into a sleeve 11 adapted to said chamber and soldered firmly thereto. The closed chamber is preferably defined by an acid-proof and stainless material.

Subsequent to connecting the copper casings of the optical fibre cables to the splice enclosing chamber, distance keeping connecting elements 7 are placed between the fastener rings and the chamber is fixed to the connecting elements. Arranged in the chamber are means for winding the optical fibres and means for guiding said fibres in the chamber, together with one or more splice cassettes for splicing the optical fibres. The installation of optical fibres and splicing of such fibres in the chamber is effected in accordance with given instructions for optimal signal transmission.

When the optical fibres are in position in the splice enclosing chamber, the chamber is closed with two cover plates 13, which are welded firmly by a TIG-method, for instance. A shielding gas is passed through the chamber during the welding process. The cover plates are first secured with spot welds, whereafter the spaces between the spot welds are welded so as to provide a sealed chamber. The splice enclosing chamber is cooled with water upon completion of the welding process, it being ensured that no water penetrates into said chamber. The earlier introduced shielding gas can then be discharged from the system. The copper casings inserted into the sleeves in the splice enclosing chamber are then firmly welded. When welding the chamber and soldering the copper casings, it must be ensured that the chamber is not excessively heated, since the optical fibres and their splices inside the chamber may otherwise be damaged.

A leakage test is carried out on the splice enclosing chamber connected to the copper casings upon completion of the welding and soldering process, by applying leakage indicating means to the welded and soldered components. No bubbles or the like will be visible around the soldering and welding locations if welding and soldering have been carried out efficiently. Upon completion of the leakage tests, oil is delivered to the chamber through one or more closable openings 14 leading to said chamber, provided that no leakage is indicated. It must be ensured that the chamber is filled completely with oil.

The splice enclosing chamber 8, which is now gas-tight and, in particular, impervious to hydrogen gas, is provided with plastic supports 9 and possibly further connector elements, wherewith the first connector elements may have been removed so that the later connector elements will form, together with the internal chamber, a completely unit that can be inserted into a protective spacing tube 10 subsequent to having checked that all reinforcement thread tensioning screws have been tightened in the fastener rings. The sealing cones and the bending limiting devices are now connected to the spacing tube and the chamber inwardly of the spacing tube is filled with grease and closed. The now completed splice will provide satisfactory protection with regard to the ingress of hydrogen gas into the chamber.

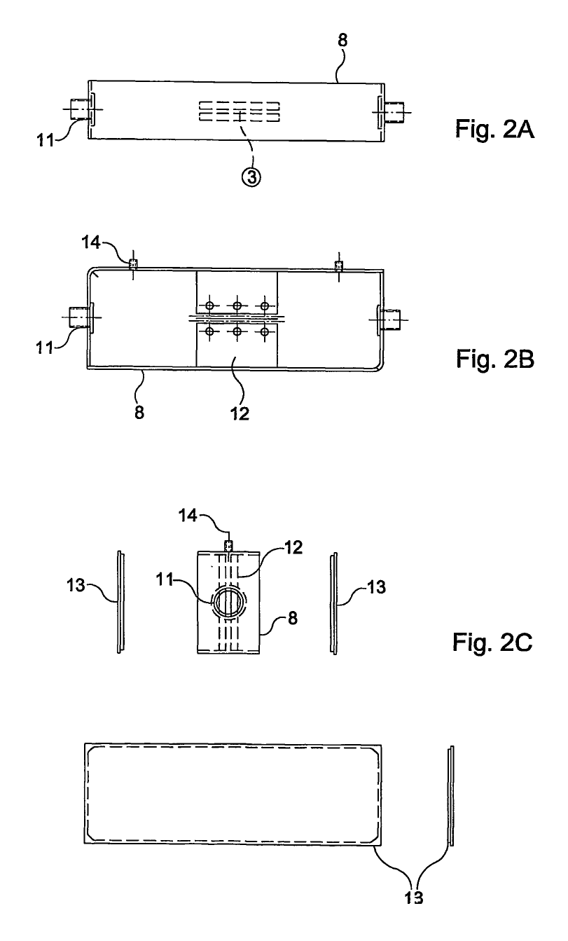

FIGS. 2A-C illustrate an embodiment of the splice enclosing chamber 8. FIG. 2A shows the chamber from above, from which it will be apparent that the tubular sleeves 11 are adapted to receive the copper casings on the optical fibre cables. FIG. 2B shows the splice enclosing chamber from one side, from which the positioning of the intermediate piece 12 for securing the optical fibres will be apparent. It will also be seen that the two closable connections 14 are arranged at the top of the chamber. FIG. 2C shows the splice enclosing chamber from one short side, and shows the position of the end sleeve 11 and the two cover plates 13 prior to their attachment to the chamber 8.

It will be understood that the invention is not restricted to the aforedescribed and illustrated exemplifying embodiment thereof and that modifications can be made within the scope of the accompanying Claims.

1. A method of providing a closed chamber for the enclosure and protection of optical fibres and/or optical fibre ribbons and splices on the optical fibres and/or the optical fibre ribbons of spliced optical fibre cables, particularly for spliced underwater optical fibre cables, characterised in that the chamber is provided to be closable with a closable and covering device onto at least one closable first opening, in that the optical fibre cables are inserted into the chamber through closable second and third openings and are spliced in the chamber, in that the chamber is closed with the closable covering device e.g., by welding at least one cover plate onto the first opening, in that the closable second and third openings are closed; and in that oil is delivered to said chamber through at least one fourth closable opening of the chamber, therewith providing a gas-tight and oil-filled chamber for protection of the spliced optical fibres and/or the optical fibre ribbons of said optical fibre cables.

2. A method according to claim 1, characterised in that the splice enclosing chamber is comprised of a stainless material.

3. A method according to claim 2, characterised in that the chamber is comprised of an acid-proof material.

4. A device for protecting splices on optical fibres and/or optical fibre ribbons of a spliced optical fibre cables, particularly for protecting spliced underwater optical fibre cables, characterised in that with at least one first opening with a closable covering device as a cover plate (13) a closable splicing chamber (8) is provided for protecting of optical fibres and/or optical fibre ribbons and their splices with space for surplus optical fibres and/or optical fibre ribbons, which fibres and ribbons are provided to be inserted into the chamber through second and third closable openings (11) of the chamber; in that the chamber can be closed by welding of the cover plate (13) to the chamber; and in that at least one closable opening (14) is provided in the defining surface of said closed chamber for supply or evacuation of gas, and for the supply of a liquid, such as a protective oil.

5. A device according to claim 4, characterised in that the closed chamber is comprised of a stainless material.

6. A device according to claim 5, characterised in that the closed chamber is comprised of an acid-proof material.

7. A device according to claim 4, characterised in that the closed chamber (8) is connected to and protected by an outer spacing tube (10).

8. A device according to claim 7, characterised in that the chamber between the protected chamber (8) and the outer spacing tube (10) is filled with a protective material, such as grease.
